(19) United States
(12) Patent Application Publication
(10) Pub. No.: US 2004/0210689 A1
(43) Pub. Date: Oct. 21, 2004

(54) Timing information generating apparatus

(75) Inventor: Genichi Tanaka, Tokyo (JP)

Correspondence Address: BURNS DOANE SWECKER & MATHIS L L P, POST OFFICE BOX 1404, ALEXANDRIA, VA, 22313-1404, US

(73) Assignee: RENESAS TECHNOLOGY CORP.

(21) Appl. No.: 10/689,592

(22) Filed: Oct. 22, 2003

(30) Foreign Application Priority Data
Apr. 21, 2003 (JP) 2003-115940

(51) Int. Cl. G06F 3/00

(52) U.S. Cl. 710/58

(57) ABSTRACT

A timing information generating apparatus includes an input/output information identifying unit, a delay time calculating unit and a timing information output unit. The input/output information identifying unit compares logical connection information with a library to identify intra-block input stage sequential circuits contributing to information exchange with extra-block input stage sequential circuits, and intra-block output stage sequential circuits contributing to information exchange with extra-block output stage sequential circuits. According to timing constraint information, the delay time calculating unit sets first delay times from input pins to the intra-block input stage sequential circuits, and second delay times from the intra-block output stage sequential circuits to output pins. The timing information output unit outputs timing information including the first delay times and the second delay times.

### BACKGROUND OF THE INVENTION

1. Field of the Invention

The present invention relates to a timing information generating apparatus for generating timing information used for timing verification conducted to design a semiconductor integrated circuit.

2. Description of Related Art

A semiconductor integrated circuit is sometimes designed using a bottom-up design method that successively repeats designing lower-level functional blocks, and then designing higher-level functional blocks using previous results. In this case, timing verification is carried out after the design of the lower-level functional blocks and after the design of the higher-level functional blocks. The timing verification of the higher-level functional blocks utilizes the timing information obtained by the timing verification of the lower-level functional blocks.

The following Relevant Reference 1 discloses a restriction-on-logic-synthesis generating and processing apparatus for generating restrictions for suitably distributing restrictions on paths across blocks on a block by block basis, when optimizing hardware designed hierarchically by blocks on a block by block basis.

Relevant Reference 1: Japanese patent application laid-open No. 2000-215224.

The bottom-up design of the semiconductor integrated circuit is carried out as described above. In this case, it is preferable that the design of all the lower-level functional blocks be completed in the process of designing the lower-level functional blocks, and the timing verification of all the lower-level functional blocks be conducted thereafter. However, it sometimes takes place that the design of some lower-level functional blocks is not completed in the design process of the lower-level functional blocks, and hence the subsequent timing verification cannot be conducted as to the some lower-level functional blocks. In this case, because of the lack of the timing information on the some lower-level functional blocks, the timing verification of the higher-level functional blocks is conducted without considering the some lower-level functional blocks. As a result, the design technique presents a problem in that the timing verification of the higher-level functional blocks is not fully achieved.

### SUMMARY OF THE INVENTION

The present invention is implemented to solve the foregoing problem. It is therefore an object of the present invention to provide a timing information generating apparatus for generating timing information on functional blocks for fully achieving the timing verification of the higher-level functional blocks, even if the design of some lower-level functional blocks has not yet been completed, and hence the timing verification of the some lower-level functional blocks is not completed.

According to one aspect of the present invention, there is provided a timing information generating apparatus for generating timing information on a functional block, the timing information generating apparatus including: an input/output information identifying unit for identifying intra-block input stage sequential circuits and intra-block output stage sequential circuits by comparing logical connection information with a library, the intra-block input stage sequential circuits being placed in the functional block and contributing to information exchange with extra-block input stage sequential circuits outside the functional block through input pins, and the intra-block output stage sequential circuits being placed in the functional block and contributing to information exchange with extra-block output stage sequential circuits outside the functional block through output pins; a delay time calculating unit for calculating first delay times from the input pins to the intra-block input stage sequential circuits in accordance with timing constraint information describing timing constraint on the functional block, and second delay times from the intra-block output stage sequential circuits to the output pins; and a timing information output unit for outputting timing information including the first delay times and the second delay times. Thus, even if the design of some lower-level functional blocks has not yet been completed, and hence their timing verification is not carried out, the timing information generating apparatus can fully conduct the timing verification of the higher-level functional blocks.

### BRIEF DESCRIPTION OF THE DRAWINGS

FIG. 1 is a block diagram showing a configuration of an embodiment 1 of the timing information generating apparatus in accordance with the present invention;

FIG. 2 is a flowchart illustrating the operation of the timing information generating apparatus as shown in FIG. 1;

FIG. 3 is a schematic diagram representing a compared result between logical connection information and a library, which relate to a functional block whose design has not yet been completed;

FIG. 4 is a schematic diagram representing a result of identifying an intra-block input stage sequential circuit and intra-block output stage sequential circuit in accordance with the compared result between the logical connection information and the library which relate to the functional block whose design has not yet been completed;

FIG. 5 is a schematic diagram used for explaining the operation of a delay time calculating unit constituting the embodiment 1 of the timing information generating apparatus in accordance with the present invention;

FIG. 6 is a schematic diagram used for explaining the operation of the delay time calculating unit constituting the embodiment 1 of the timing information generating apparatus;

FIG. 7 is a schematic diagram used for explaining the operation of the delay time calculating unit constituting an embodiment 2 of the timing information generating apparatus;

FIG. 8 is a schematic diagram used for explaining the operation of the delay time calculating unit constituting an embodiment 3 of the timing information generating apparatus;

FIG. 9 is a schematic diagram used for explaining the operation of the delay time calculating unit constituting an embodiment 4 of the timing information generating apparatus;

FIG. 10 is a schematic diagram used for explaining the operation of the delay time calculating unit constituting an embodiment 5 of the timing information generating apparatus;

FIG. 11 is a block diagram showing a configuration of an embodiment 7 of the timing information generating apparatus in accordance with the present invention;

FIG. 12 is a flowchart illustrating the operation of the timing information generating apparatus as shown in FIG. 11;

FIG. 13 is a block diagram showing a configuration of an embodiment 10 of the timing information generating apparatus in accordance with the present invention;

FIG. 14 is a flowchart illustrating the operation of the timing information generating apparatus as shown in FIG. 13; and

FIG. 15 is a schematic diagram used for explaining the operation of a load capacitance specifying unit constituting the timing information generating apparatus.

### DETAILED DESCRIPTION OF THE PREFERRED EMBODIMENTS

The invention will now be described with reference to the accompanying drawings.

### Embodiment 1

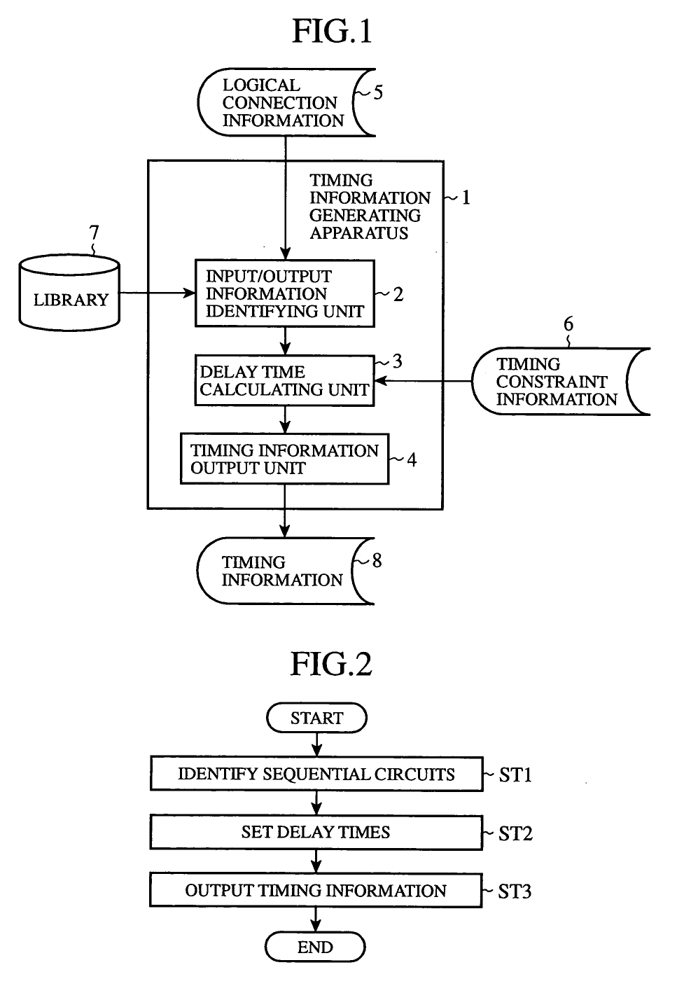

FIG. 1 is a block diagram showing a configuration of an embodiment 1 of the timing information generating apparatus in accordance with the present invention.

The timing information generating apparatus 1 comprises an input/output information identifying unit 2, a delay time calculating unit 3, and a timing information output unit 4. Logical connection information 5 describes connection relationships between circuit components constituting a functional block, between the circuit components and input pins, and between the circuit components and output pins. Timing constraint information 6 describes timing constraints on the functional block such as the period of a clock signal, a clock skew, a path (such as a false path (false_path), disable path (disable_path), and multi-cycle path (multicycle_path)) for carrying out exception handling of the timing verification, load capacitances of the input pins toward the outside of the functional block, load resistances of the input pins toward the outside of the functional block, cells for driving the input pins or their driving power, delay times from sequential circuits outside the functional block to the input pins, load capacitances of the output pins toward the outside of its functional block, load resistances of the output pins toward the outside of the functional block, and delay times from the output pins to sequential circuits outside the functional block. A library 7 registers cells used for the design of functional blocks.

The input/output information identifying unit 2 compares the logical connection information 5 with the library 7 to identify intra-block input stage sequential circuits and intra-block output stage sequential circuits. Here, the intra-block input stage sequential circuit refers to a sequential circuit that is placed within the functional block whose design has not yet been completed, and contributes to information exchange with a sequential circuit outside the functional block (called “extra-block input stage sequential circuit” from now on) via the input pin. Likewise, the intra-block output stage sequential circuit refers to a sequential circuit that is placed within the functional block whose design has not yet been completed, and contributes to information exchange with a sequential circuit outside the functional block (called “extra-block output stage sequential circuit” from now on) via the output pin. The intra-block input stage sequential circuit is a first sequential circuit reached when proceeding from the input pin in the direction of the signal transmission. The extra-block input stage sequential circuit is a first sequential circuit reached when proceeding from the input pin in the opposite direction of the signal transmission. The intra-block output stage sequential circuit is a first sequential circuit reached when proceeding from the output pin in the opposite direction of the signal transmission. The extra-block output stage sequential circuit is a first sequential circuit reached when proceeding from the output pin in the direction of the signal transmission.

According to the timing constraint information 6, the delay time calculating unit 3 sets delay times from the input pins to the intra-block input stage sequential circuits, and delay times from the intra-block output stage sequential circuits to the output pins.

More specifically, the present embodiment sets the delay times from the input pins to the intra-block input stage sequential circuits and the delay times from the intra-block output stage sequential circuits to the output pins in such a manner that all the input pins and output pins exactly satisfy the conditions described in the timing constraint information 6. To achieve this, the delay time calculating unit 3 of the present embodiment obtains information transmission time T1 from the extra-block input stage sequential circuit to the intra-block input stage sequential circuit from the clock signal supplied to the intra-block input stage sequential circuit and the clock signal supplied to the extra-block input stage sequential circuit described in the timing constraint information 6. Likewise, the delay time calculating unit 3 obtains information transmission time T2 from the intra-block output stage sequential circuit to the extra-block output stage sequential circuit from the clock signal supplied to the intra-block output stage sequential circuit and the clock signal supplied to the extra-block output stage sequential circuit described in the timing constraint information 6. Then, using a delay time T3 from the extra-block input stage sequential circuit to the input pin and the information transmission time T1 from the extra-block input stage sequential circuit to the intra-block input stage sequential circuit described in the timing constraint information 6, the delay time calculating unit 3 obtains a delay time T4 from the input pin to the intra-block input stage sequential circuit by T1−T3. Likewise, using a delay time T5 from the output pin to the extra-block output stage sequential circuit and the information transmission time T2 from the intra-block output stage sequential circuit to the extra-block output stage sequential circuit described in the timing constraint information 6, the delay time calculating unit 3 obtains a delay time T6 from the intra-block output stage sequential circuit to the output pin by T2−T5.

The timing information output unit 4 outputs timing information 8 including information on the delay times from the input pins to the intra-block input stage sequential circuits and the delay times from the intra-block output stage sequential circuits to the output pins.

Next, the operation of the present embodiment 1 will be described.

FIG. 2 is a flowchart illustrating the operation of the timing information generating apparatus as shown in FIG. 1.

First, the input/output information identifying unit 2 receives the logical connection information 5. Then, it compares the logical connection information 5 and the library 7, and identifies the intra-block input stage sequential circuits that contribute to the information exchange with the extra-block input stage sequential circuits, and the intra-block output stage sequential circuits that contribute to the information exchange with the extra-block output stage sequential circuits at step ST1.

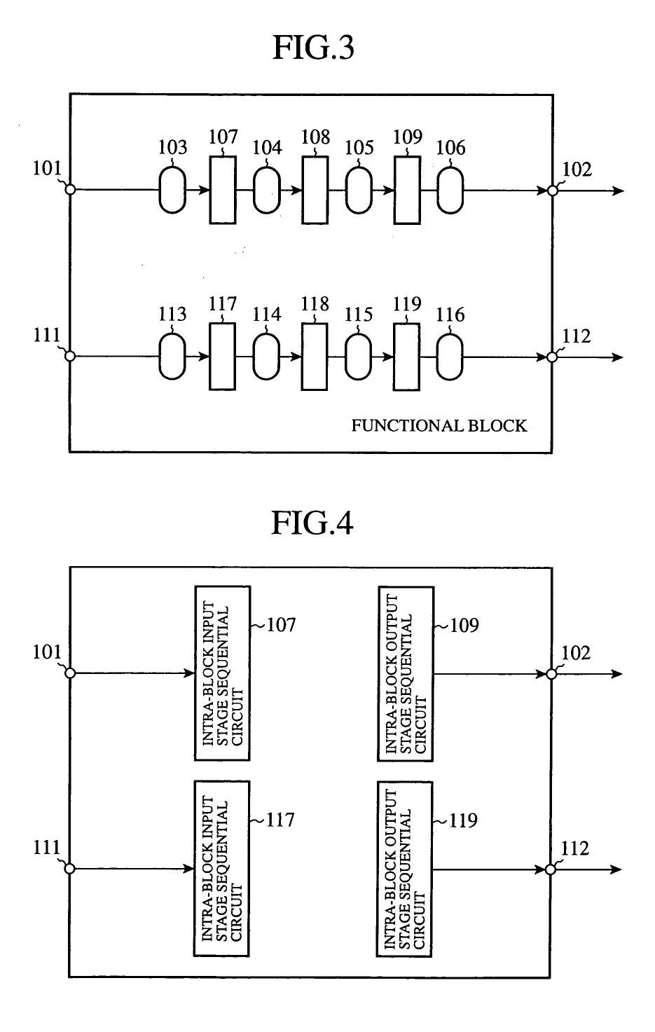

FIG. 3 is a schematic diagram illustrating the compared result between the logical connection information and the library which relate to the functional block whose design has not yet been completed. FIG. 4 is a schematic diagram illustrating the result of identifying the intra-block input stage sequential circuits and intra-block output stage sequential circuits in accordance with the compared result between the logical connection information and the library which relate to the functional block whose design has not yet been completed.

For example, assume that four combinational circuit sections 103-106 and three sequential circuits 107-109 are present between a first input pin 101 and a first output pin 102, and four combinational circuit sections 113-116 and three sequential circuits 117-119 are present between a second input pin 111 and a second output pin 112 as illustrated in FIG. 3, as a result of the comparison between the logical connection information and the library which relate to the functional block whose design has not yet been completed. In this case, as illustrated in FIG. 4, the sequential circuits 107 and 117 are each identified as the intra-block input stage sequential circuit, and the sequential circuits 109 and 119 are each identified as the intra-block output stage sequential circuit. The combinational circuit sections 103-106 and 113-116 can consist of a single combinational circuit or a plurality of combinational circuits, or include no combinational circuit.

Subsequently, the delay time calculating unit 3 receives the timing constraint information 6 and the identified result output from the input/output information identifying unit 2. Then, in response to the timing constraint information 6, the delay time calculating unit 3 sets the delay times from the input pins to the intra-block input stage sequential circuits and the delay times from the intra-block output stage sequential circuits to the output pins at step ST2.

More specifically, in the present embodiment, the delay time calculating unit 3 obtains the information transmission time T1 from the extra-block input stage sequential circuit to the intra-block input stage sequential circuit from the clock signal supplied to the intra-block input stage sequential circuit and the clock signal supplied to the extra-block input stage sequential circuit described in the timing constraint information 6. The delay time calculating unit 3 also obtains the information transmission time T2 from the intra-block output stage sequential circuit to the extra-block output stage sequential circuit from the clock signal supplied to the intra-block output stage sequential circuit and the clock signal supplied to the extra-block output stage sequential circuit described in the timing constraint information 6. Then, using the delay time T3 from the extra-block input stage sequential circuit to the input pin and the information transmission time T1 from the extra-block input stage sequential circuit to the intra-block input stage sequential circuit described in the timing constraint information 6, the delay time calculating unit 3 obtains the delay time T4 from the input pin to the intra-block input stage sequential circuit by T1−T3. Likewise, using the delay time T5 from the output pin to the extra-block output stage sequential circuit and the information transmission time T2 from the intra-block output stage sequential circuit to the extra-block output stage sequential circuit described in the timing constraint information 6, the delay time calculating unit 3 obtains the delay time T6 from the intra-block output stage sequential circuit to the output pin by T2−T5.

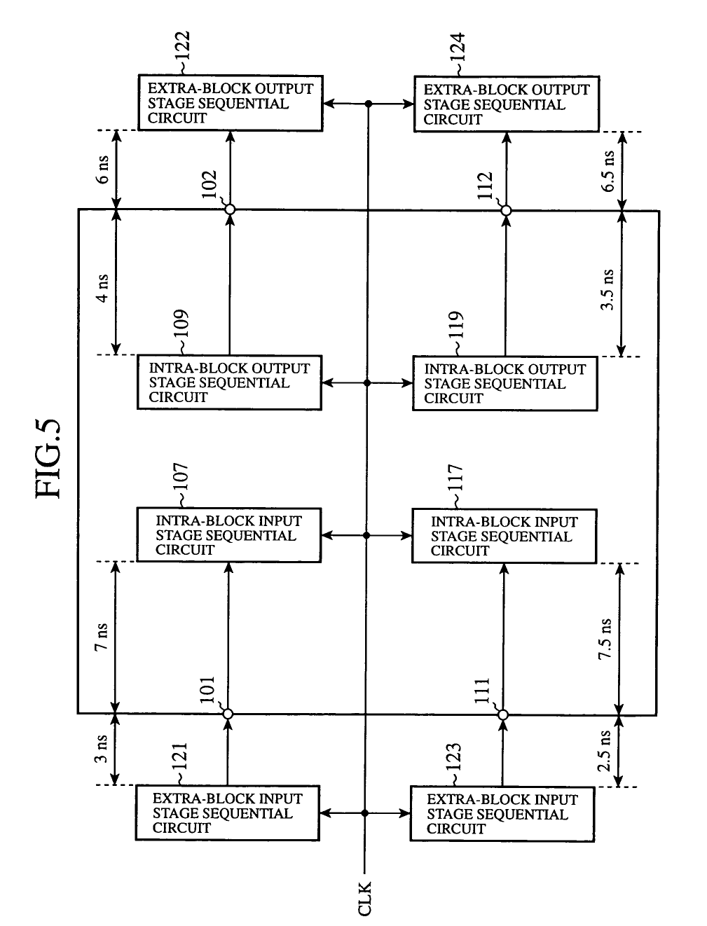

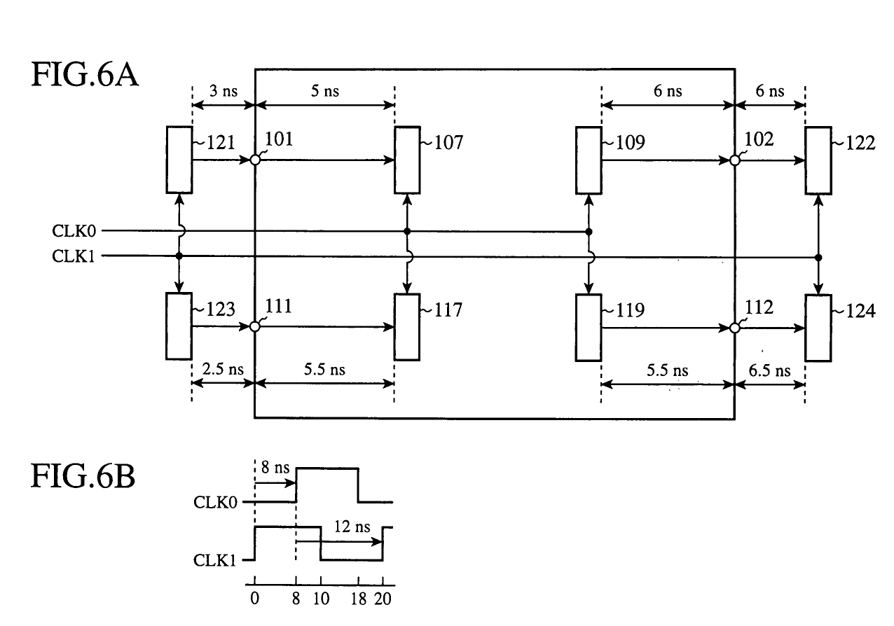

FIGS. 5, 6A and 6B are schematic diagrams used for explaining the operation of the delay time calculating unit 3 of the present embodiment 1 of the timing information generating apparatus, which illustrates a method of calculating the delay times from the input pins to the intra-block input stage sequential circuits and the delay times from the intra-block output stage sequential circuits to the output pins in accordance with the timing constraint information.

For example, as illustrated in FIG. 5, let us consider the case where the same clock signal (denoted by CLK in FIG. 5) is supplied to the first and second intra-block input stage sequential circuits 107 and 117, to the first and second extra-block input stage sequential circuits 121 and 123, to the first and second intra-block output stage sequential circuits 109 and 119, and to the first and second extra-block output stage sequential circuits 122 and 124. In this case, the information transmission time from the first extra-block input stage sequential circuit 121 to the first intra-block input stage sequential circuit 107, the information transmission time from the first intra-block output stage sequential circuit 109 to the first extra-block output stage sequential circuit 122, the information transmission time from the second extra-block input stage sequential circuit 123 to the second intra-block input stage sequential circuit 117 and the information transmission time from the second intra-block output stage sequential circuit 119 to the second extra-block output stage sequential circuit 124 each agree with the period of the clock signal. Assume that the period of the clock signal is 10 ns, the delay time from the first extra-block input stage sequential circuit 121 to the first input pin 101 is 3 ns, the delay time from the first output pin 102 to the first extra-block output stage sequential circuit 122 is 6 ns, the delay time from the second extra-block input stage sequential circuit 123 to the second input pin 111 is 2.5 ns, and the delay time from the second output pin 112 to the second extra-block output stage sequential circuit 124 is 6.5 ns. In this case, the delay time calculating unit 3 sets the delay time from the first input pin 101 to the first intra-block input stage sequential circuit 107 at 7 ns (10 ns−3 ns), the delay time from the first intra-block output stage sequential circuit 109 to the first output pin 102 at 4 ns (10 ns−6 ns), the delay time from the second input pin 111 to the second intra-block input stage sequential circuit 117 at 7.5 ns (10 ns−2.5 ns), and the delay time from the second intra-block output stage sequential circuit 119 to the second output pin 112 at 3.5 ns (10 ns−6.5 ns).

Alternatively, as shown in FIG. 6A, assume that although a clock signal (denoted by CLK0 in FIG. 6A) supplied to the first and second intra-block input stage sequential circuits 107 and 117 and to the first and second intra-block output stage sequential circuits 109 and 119 has the same period 10 ns as a clock signal (denoted by CLK1 in FIG. 6A) supplied to the first and second extra-block input stage sequential circuits 121 and 123 and to the first and second extra-block output stage sequential circuits 122 and 124, and their timing is shifted by 8 ns as illustrated in FIG. 6B, and that the information is transferred at the rising edge of the clock signals. In this case, the information transmission time from the first extra-block input stage sequential circuit 121 to the first intra-block input stage sequential circuit 107 and the information transmission time from the second extra-block input stage sequential circuit 123 to the second intra-block input stage sequential circuit 117 are 8 ns, whereas the information transmission time from the first intra-block output stage sequential circuit 109 to the first extra-block output stage sequential circuit 122 and the information transmission time from the second intra-block output stage sequential circuit 119 to the second extra-block output stage sequential circuit 124 are 12 ns. Let us further assume that the delay time from the first extra-block input stage sequential circuit 121 to the first input pin 101 is 3 ns, the delay time from the first output pin 102 to the first extra-block output stage sequential circuit 122 is 6 ns, the delay time from the second extra-block input stage sequential circuit 123 to the second input pin 111 is 2.5 ns, and the delay time from the second output pin 112 to the second extra-block output stage sequential circuit 124 is 6.5 ns. In this case, the delay time from the first input pin 101 to the first intra-block input stage sequential circuit 107 is set at 5 ns (8 ns−3 ns), the delay time from the first intra-block output stage sequential circuit 109 to the first output pin 102 is set at 6 ns (12 ns−6 ns), the delay time from the second input pin 111 to the second intra-block input stage sequential circuit 117 is set at 5.5 ns (8 ns−2.5 ns), and the delay time from the second intra-block output stage sequential circuit 119 to the second output pin 112 is set at 5.5 ns (12 ns−6.5 ns).

Subsequently, the timing information output unit 4 receives the set results the delay time calculating unit 3 outputs, and outputs the timing information 8 including the delay times from the input pins to the intra-block input stage sequential circuits and the delay times from the intra-block output stage sequential circuits to the output pins at step ST3.

As described above, the present embodiment 1 sets, in the functional block whose design has not yet been completed, the delay times from the input pins to the intra-block input stage sequential circuits and the delay times from the intra-block output stage sequential circuits to the output pins, and generates the timing information including the delay times. As a result, even if the design of some lower-level functional blocks has not yet been completed, and the timing verification of the some lower-level functional blocks has not yet been carried out, the timing verification of the higher-level functional blocks can be fully conducted.

### Embodiment 2

The present embodiment 2 sets the delay times from the input pins to the intra-block input stage sequential circuits and the delay times from the intra-block output stage sequential circuits to the output pins such that all the input pins and output pins satisfy the conditions described in the timing constraint information 6 with leaving the same spare time.

More specifically, in the present embodiment, the delay time calculating unit 3 obtains the information transmission time T1 from the extra-block input stage sequential circuit to the intra-block input stage sequential circuit from the clock signal supplied to the intra-block input stage sequential circuit and the clock signal supplied to the extra-block input stage sequential circuit described in the timing constraint information 6. The delay time calculating unit 3 also obtains the information transmission time T2 from the intra-block output stage sequential circuit to the extra-block output stage sequential circuit from the clock signal supplied to the intra-block output stage sequential circuit and the clock signal supplied to the extra-block output stage sequential circuit described in the timing constraint information 6. Then, when the same spare time t1 is specified for all the input pins and output pins uniformly, using the delay time T3 from the extra-block input stage sequential circuit to the input pin and the information transmission time T1 from the extra-block input stage sequential circuit to the intra-block input stage sequential circuit described in the timing constraint information 6, the delay time calculating unit 3 obtains the delay time T4 from the input pin to the intra-block input stage sequential circuit by T1−T3−t1. Likewise, using the delay time T5 from the output pin to the extra-block output stage sequential circuit and the information transmission time T2 from the intra-block output stage sequential circuit to the extra-block output stage sequential circuit described in the timing constraint information 6, the delay time calculating unit 3 obtains the delay time T6 from the intra-block output stage sequential circuit to the output pin by T2−T5−t1.

The spare time for the input pins and output pins is determined uniformly by the delay time calculating unit 3 in accordance with (1) the period of the clock signal described in the timing constraint information 6; (2) the delay time described in the timing information 6; and (3) the process conditions used, for example. The spare time for the input pins and output pins can be determined uniformly by a user from experience. When the user decides it, the delay time calculating unit 3 determines the spare time for the input pins and output pins in accordance with the information input by the user via an input means not shown in the drawings.

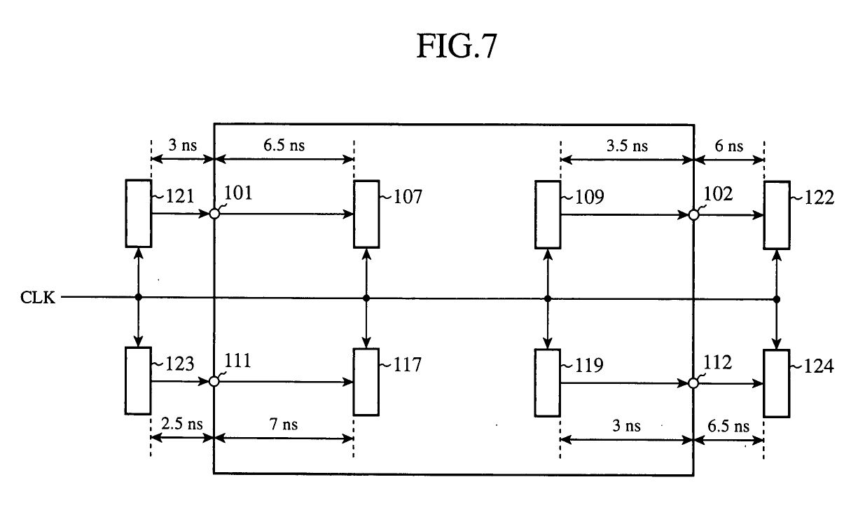

FIG. 7 is a schematic diagrams used for explaining the operation of the delay time calculating unit of the present embodiment 2 of the timing information generating apparatus.

For example, as illustrated in FIG. 7, let us consider the case where the same clock signal (denoted by CLK in FIG. 7) is supplied to the first and second intra-block input stage sequential circuits 107 and 117, to the first and second extra-block input stage sequential circuits 121 and 123, to the first and second intra-block output stage sequential circuits 109 and 119, and to the first and second extra-block output stage sequential circuits 122 and 124, and that the period of the clock signal is 10 ns, the delay time from the first extra-block input stage sequential circuit 121 to the first input pin 101 is 3 ns, the delay time from the first output pin 102 to the first extra-block output stage sequential circuit 122 is 6 ns, the delay time from the second extra-block input stage sequential circuit 123 to the second input pin 111 is 2.5 ns, the delay time from the second output pin 112 to the second extra-block output stage sequential circuit 124 is 6.5 ns, and the spare time for all the input pins and output pins is 0.5 ns. In this case, the delay time calculating unit 3 sets the delay time from the first input pin 101 to the first intra-block input stage sequential circuit 107 at 6.5 ns (10 ns−3 ns−0.5 ns), the delay time from the first intra-block output stage sequential circuit 109 to the first output pin 102 at 3.5 ns (10 ns−6 ns−0.5 ns), the delay time from the second input pin 111 to the second intra-block input stage sequential circuit 117 at 7 ns (10 ns−2.5 ns−0.5 ns), and the delay time from the second intra-block output stage sequential circuit 119 to the second output pin 112 at 3 ns (10 ns−6.5 ns−0.5 ns).

As described above, the present embodiment 2 sets, in the functional block whose design has not yet been completed, the delay times from the input pins to the intra-block input stage sequential circuits and the delay times from the intra-block output stage sequential circuits to the output pins, and generates the timing information including the delay times. As a result, the present embodiment 2 offers the same advantages as the foregoing embodiment 1.

### Embodiment 3

The present embodiment 3 sets the delay times from the input pins to the intra-block input stage sequential circuits and the delay times from the intra-block output stage sequential circuits to the output pins such that the conditions described in the timing constraint information 6 as to the input pins and output pins are satisfied with leaving different spare times.

More specifically, in the present embodiment, the delay time calculating unit 3 obtains the information transmission time T1 from the extra-block input stage sequential circuit to the intra-block input stage sequential circuit from the clock signal supplied to the intra-block input stage sequential circuit and the clock signal supplied to the extra-block input stage sequential circuit described in the timing constraint information 6. The delay time calculating unit 3 also obtains the information transmission time T2 from the intra-block output stage sequential circuit to the extra-block output stage sequential circuit from the clock signal supplied to the intra-block output stage sequential circuit and the clock signal supplied to the extra-block output stage sequential circuit described in the timing constraint information 6. Then, when the spare time for the input pins is t2, and the spare time for the output pins is t3, using the delay time T3 from the extra-block input stage sequential circuit to the input pin and the information transmission time T1 from the extra-block input stage sequential circuit to the intra-block input stage sequential circuit described in the timing constraint information 6, the delay time calculating unit 3 obtains the delay time T4 from the input pin to the intra-block input stage sequential circuit by T1−T3−t2. Likewise, using the delay time T5 from the output pin to the extra-block output stage sequential circuit and the information transmission time T2 from the intra-block output stage sequential circuit to the extra-block output stage sequential circuit described in the timing constraint information 6, the delay time calculating unit 3 obtains the delay time T6 from the intra-block output stage sequential circuit to the output pin by T2−T5−t3.

The spare times for the input pins and output pins is determined individually by the delay time calculating unit 3 in accordance with (1) the period of the clock signal described in the timing constraint information 6; (2) the delay time described in the timing information 6; and (3) the process conditions used, for example. The spare times for the input pins and output pins can be decided individually by a user from experience. When the user decides them, the delay time calculating unit 3 determines the spare times for the input pins and output pins in accordance with the information input by the user via an input means not shown in the drawings.

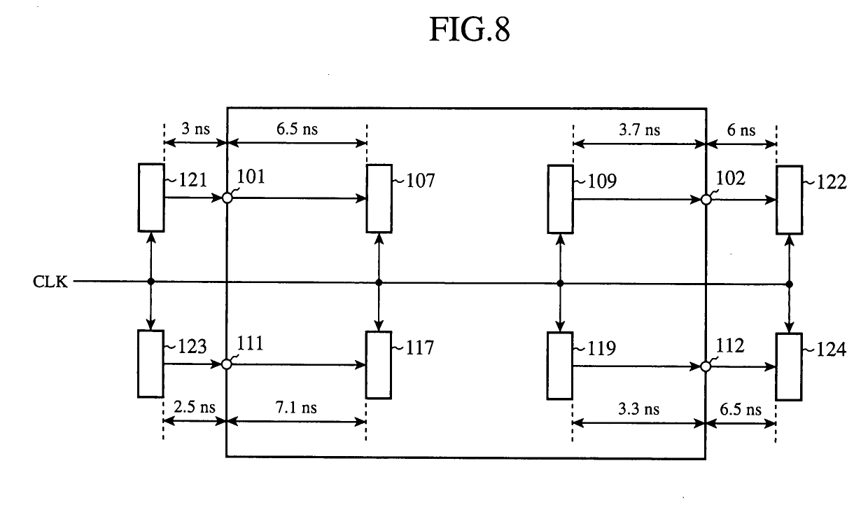

FIG. 8 is a schematic diagrams used for explaining the operation of the delay time calculating unit of the present embodiment 3 of the timing information generating apparatus.

For example, as illustrated in FIG. 8, let us consider the case where the same clock signal (denoted by CLK in FIG. 8) is supplied to the first and second intra-block input stage sequential circuits 107 and 117, to the first and second extra-block input stage sequential circuits 121 and 123, to the first and second intra-block output stage sequential circuits 109 and 119, and to the first and second extra-block output stage sequential circuits 122 and 124, that the period of the clock signal is 10 ns, the delay time from the first extra-block input stage sequential circuit 121 to the first input pin 101 is 3 ns, the delay time from the first output pin 102 to the first extra-block output stage sequential circuit 122 is 6 ns, the delay time from the second extra-block input stage sequential circuit 123 to the second input pin 111 is 2.5 ns, and the delay time from the second output pin 112 to the second extra-block output stage sequential circuit 124 is 6.5 ns, and that the spare time for the first input pin 101 is 0.5 ns, the spare time for the first output pin 102 is 0.3 ns, the spare time for the second input pins 111 is 0.4 ns, and the spare time for the second output pins 112 is 0.2 ns. In this case, the delay time calculating unit 3 sets the delay time from the first input pin 101 to the first intra-block input stage sequential circuit 107 at 6.5 ns (10 ns−3 ns−0.5 ns), the delay time from the first intra-block output stage sequential circuit 109 to the first output pin 102 at 3.7 ns (10 ns−6 ns−0.3 ns), the delay time from the second input pin 111 to the second intra-block input stage sequential circuit 117 at 7.1 ns (10 ns−2.5 ns−0.4 ns), and the delay time from the second intra-block output stage sequential circuit 119 to the second output pin 112 at 3.3 ns (10 ns−6.5 ns−0.2 ns).

As described above, the present embodiment 3 sets, in the functional block whose design has not yet been completed, the delay times from the input pins to the intra-block input stage sequential circuits and the delay times from the intra-block output stage sequential circuits to the output pins, and generates the timing information including the delay times. As a result, the present embodiment 3 offers the same advantages as the foregoing embodiment 1.

### Embodiment 4

The present embodiment 4 sets the delay times from the input pins to the intra-block input stage sequential circuits and the delay times from the intra-block output stage sequential circuits to the output pins such that none of the input pins and output pins satisfy the conditions described in the timing constraint information 6 with a uniform shortage of time.

More specifically, in the present embodiment, the delay time calculating unit 3 obtains the information transmission time T1 from the extra-block input stage sequential circuit to the intra-block input stage sequential circuit from the clock signal supplied to the intra-block input stage sequential circuit and the clock signal supplied to the extra-block input stage sequential circuit described in the timing constraint information 6. The delay time calculating unit 3 also obtains the information transmission time T2 from the intra-block output stage sequential circuit to the extra-block output stage sequential circuit from the clock signal supplied to the intra-block output stage sequential circuit and the clock signal supplied to the extra-block output stage sequential circuit described in the timing constraint information 6. Then, when the same shortage of time t4 is specified for all the input pins and output pins, using the delay time T3 from the extra-block input stage sequential circuit to the input pin and the information transmission time T1 from the extra-block input stage sequential circuit to the intra-block input stage sequential circuit described in the timing constraint information 6, the delay time calculating unit 3 obtains the delay time T4 from the input pin to the intra-block input stage sequential circuit by T1−T3+t4. Likewise, using the delay time T5 from the output pin to the extra-block output stage sequential circuit and the information transmission time T2 from the intra-block output stage sequential circuit to the extra-block output stage sequential circuit described in the timing constraint information 6, the delay time calculating unit 3 obtains the delay time T6 from the intra-block output stage sequential circuit to the output pin by T2−T5+t4.

The shortage of time for the input pins and output pins is determined uniformly by the delay time calculating unit 3 in accordance with (1) the period of the clock signal described in the timing constraint information 6; (2) the delay time described in the timing information 6; and (3) the process conditions used, for example. The shortage of time for the input pins and output pins can be determined uniformly by a user from experience. When the user decides it, the delay time calculating unit 3 determines the shortage of time for the input pins and output pins in accordance with the information input by the user via an input means not shown in the drawings.

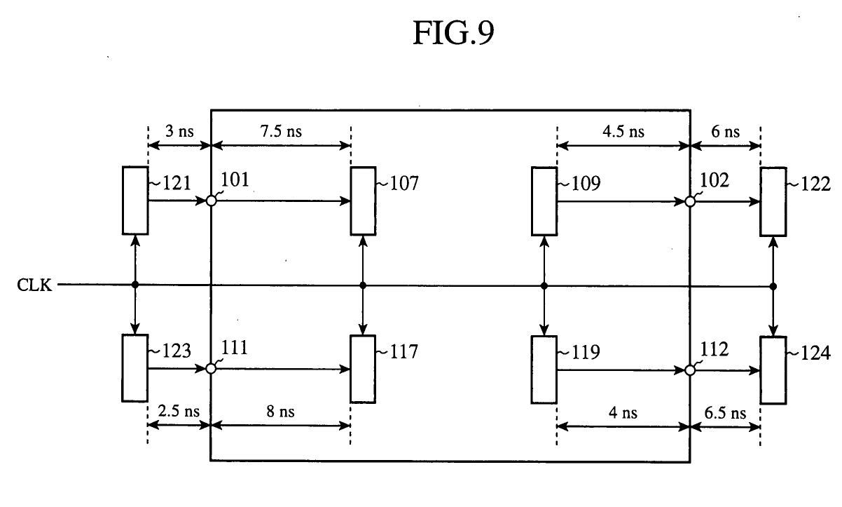

FIG. 9 is a schematic diagrams used for explaining the operation of the delay time calculating unit of the present embodiment 4 of the timing information generating apparatus.

For example, as illustrated in FIG. 9, let us consider the case where the same clock signal (denoted by CLK in FIG. 9) is supplied to the first and second intra-block input stage sequential circuits 107 and 117, to the first and second extra-block input stage sequential circuits 121 and 123, to the first and second intra-block output stage sequential circuits 109 and 119, and to the first and second extra-block output stage sequential circuits 122 and 124, and that the period of the clock signal is 10 ns, the delay time from the first extra-block input stage sequential circuit 121 to the first input pin 101 is 3 ns, the delay time from the first output pin 102 to the first extra-block output stage sequential circuit 122 is 6 ns, the delay time from the second extra-block input stage sequential circuit 123 to the second input pin 111 is 2.5 ns, the delay time from the second output pin 112 to the second extra-block output stage sequential circuit 124 is 6.5 ns and the shortage of time for all the input pins and output pins is 0.5 ns. In this case, the delay time calculating unit 3 sets the delay time from the first input pin 101 to the first intra-block input stage sequential circuit 107 at 7.5 ns (10 ns−3 ns+0.5 ns), the delay time from the first intra-block output stage sequential circuit 109 to the first output pin 102 at 4.5 ns (10 ns−6 ns+0.5 ns), the delay time from the second input pin 111 to the second intra-block input stage sequential circuit 117 at 8 ns (10 ns−2.5 ns+0.5 ns), and the delay time from the second intra-block output stage sequential circuit 119 to the second output pin 112 at 4 ns (10 ns−6.5 ns+0.5 ns).

As described above, the present embodiment 4 sets, in the functional block whose design has not yet been completed, the delay times from the input pins to the intra-block input stage sequential circuits and the delay times from the intra-block output stage sequential circuits to the output pins, and generates the timing information including the delay times. As a result, the present embodiment offers the same advantages as the foregoing embodiment 1.

### Embodiment 5

The present embodiment 5 sets the delay times from the input pins to the intra-block input stage sequential circuits and the delay times from the intra-block output stage sequential circuits to the output pins such that the conditions described in the timing constraint information 6, which relate to the input pins and output pins, are not satisfied with leaving different shortages of time.

More specifically, in the present embodiment, the delay time calculating unit 3 obtains the information transmission time T1 from the extra-block input stage sequential circuit to the intra-block input stage sequential circuit from the clock signal supplied to the intra-block input stage sequential circuit and the clock signal supplied to the extra-block input stage sequential circuit described in the timing constraint information 6. The delay time calculating unit 3 also obtains the information transmission time T2 from the intra-block output stage sequential circuit to the extra-block output stage sequential circuit from the clock signal supplied to the intra-block output stage sequential circuit and the clock signal supplied to the extra-block output stage sequential circuit described in the timing constraint information 6. Then, when the shortage of time for the input pins is t5, and the shortage of time for the output pins is t6, using the delay time T3 from the extra-block input stage sequential circuit to the input pin and the information transmission time T1 from the extra-block input stage sequential circuit to the intra-block input stage sequential circuit described in the timing constraint information 6, the delay time calculating unit 3 obtains the delay time T4 from the input pin to the intra-block input stage sequential circuit by T1−T3+t5. Likewise, using the delay time T5 from the output pin to the extra-block output stage sequential circuit and the information transmission time T2 from the intra-block output stage sequential circuit to the extra-block output stage sequential circuit described in the timing constraint information 6, the delay time calculating unit 3 obtains the delay time T6 from the intra-block output stage sequential circuit to the output pin by T2−T5+t6.

The shortages of time for the input pins and output pins are determined individually by the delay time calculating unit 3 in accordance with (1) the period of the clock signal described in the timing constraint information 6; (2) the delay time described in the timing information 6; and (3) the process conditions used, for example. The shortages of time for the input pins and output pins can be determined individually by a user from experience. When the user decides them, the delay time calculating unit 3 determines the shortages of time for the input pins and output pins in accordance with the information input by the user via an input means not shown in the drawings.

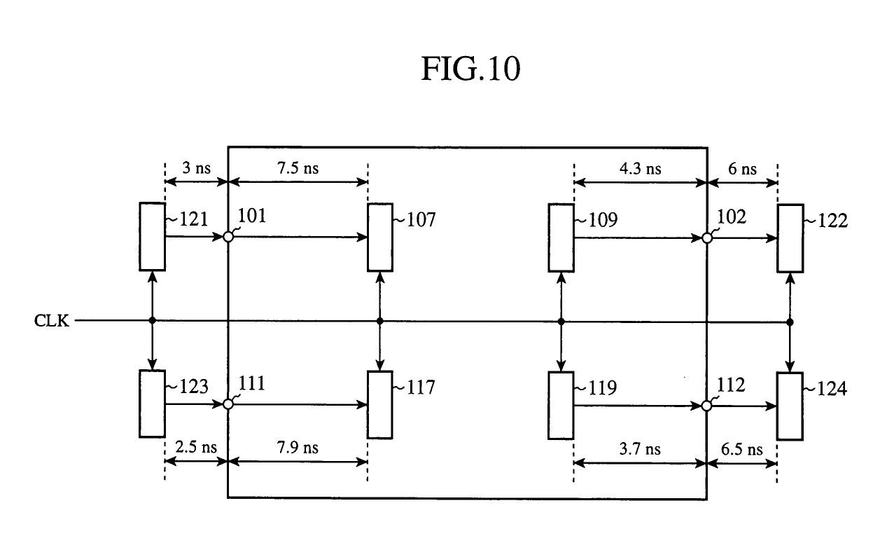

FIG. 10 is a schematic diagrams used for explaining the operation of the delay time calculating unit of the present embodiment 5 of the timing information generating apparatus.

For example, as illustrated in FIG. 10, let us consider the case where the same clock signal (denoted by CLK in FIG. 10) is supplied to the first and second intra-block input stage sequential circuits 107 and 117, to the first and second extra-block input stage sequential circuits 121 and 123, to the first and second intra-block output stage sequential circuits 109 and 119, and to the first and second extra-block output stage sequential circuits 122 and 124, that the period of the clock signal is 10 ns, the delay time from the first extra-block input stage sequential circuit 121 to the first input pin 101 is 3 ns, the delay time from the first output pin 102 to the first extra-block output stage sequential circuit 122 is 6 ns, the delay time from the second extra-block input stage sequential circuit 123 to the second input pin 111 is 2.5 ns, the delay time from the second output pin 112 to the second extra-block output stage sequential circuit 124 is 6.5 ns, and that the shortage of time for the first input pin 101 is 0.5 ns, the shortage of time for the first output pin 102 is 0.3 ns, the shortage of time for the second input pins 111 is 0.4 ns, and the shortage of time for the second output pins 112 is 0.2 ns. In this case, the delay time calculating unit 3 sets the delay time from the first input pin 101 to the first intra-block input stage sequential circuit 107 at 7.5 ns (10 ns−3 ns+0.5 ns), the delay time from the first intra-block output stage sequential circuit 109 to the first output pin 102 at 4.3 ns (10 ns−6 ns+0.3 ns), the delay time from the second input pin 111 to the second intra-block input stage sequential circuit 117 at 7.9 ns (10 ns−2.5 ns+0.4 ns), and the delay time from the second intra-block output stage sequential circuit 119 to the second output pin 112 at 3.7 ns (10 ns−6.5 ns+0.2 ns).

As described above, the present embodiment 5 sets, in the functional block whose design has not yet been completed, the delay times from the input pins to the intra-block input stage sequential circuits and the delay times from the intra-block output stage sequential circuits to the output pins, and generates the timing information including the delay times. As a result, the present embodiment offers the same advantages as the foregoing embodiment 1.

### Embodiment 6

The present embodiment is an example combining the embodiments 1-5. Specifically, as for some input pins andoutput pins, the delay times are set such that they satisfy the conditions described in the timing constraint information 6 as in the embodiment 1; as for other input pins and output pins, the delay times are set such that they satisfy the conditions described in the timing constraint information 6 with leaving the uniform spare time as in the embodiment 2; as for still other input pins and output pins, the delay times are set such that they satisfy the conditions described in the timing constraint information 6 with leaving the different spare times for the individual input pins and output pins as in the embodiment 3; as for still other input pins and output pins, the delay times are set such that they do not satisfy the conditions described in the timing constraint information 6 with the uniform shortage of time as in the embodiment 4; and as for still other input pins and output pins, the delay times are set such that they do not satisfy the conditions described in the timing constraint information 6 with the different shortages of time for the individual input pins and output pins as in the embodiment 5.

The present embodiment 6 can also offer the same advantages as described in the foregoing embodiment 1.

### Embodiment 7

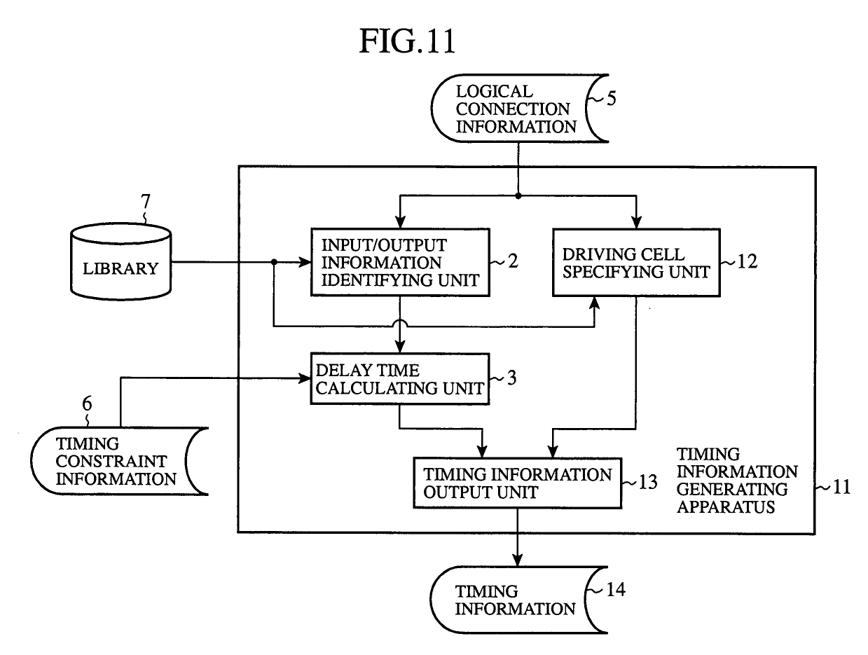

FIG. 11 is a block diagram showing a configuration of an embodiment 7 of the timing information generating apparatus in accordance with the present invention.

The timing information generating apparatus 11 comprises an input/output information identifying unit 2, a delay time calculating unit 3, a driving cell specifying unit 12 and a timing information output unit 13.

The configuration and operation of the input/output information identifying unit 2 and delay time calculating unit 3 are the same as their counterparts of the foregoing embodiment 1.

The driving cell specifying unit 12 identifies the output pins of a functional block whose design has not yet been completed from the logical connection information 5, and specifies a corresponding cell registered in the library 7 as a cells for driving the output pins.

More specifically, in the present embodiment, the driving cell specifying unit 12 identifies the output pins of the functional block whose design has not yet been completed from the logical connection information 5, and specifies the same cell registered in the library 7 uniformly as the cells for driving all the output pins.

For example, the driving cell specifying unit 12 uniformly specifies a typical cell or a frequently used cell registered in the library 7 for all the output pins. The cells for driving the output pins can also be uniformly determined by a user from experience. When the user decides it, the driving cell specifying unit 12 specifies the cells for driving the output pins in accordance with the information the user inputs via an input means not shown.

The timing information output unit 13 outputs the timing information 14 including the delay times from the input pins to the intra-block input stage sequential circuits, the delay times from the intra-block output stage sequential circuits to the output pins, and the information on the cells for driving the output pins.

Next, the operation of the present embodiment 7 will be described.

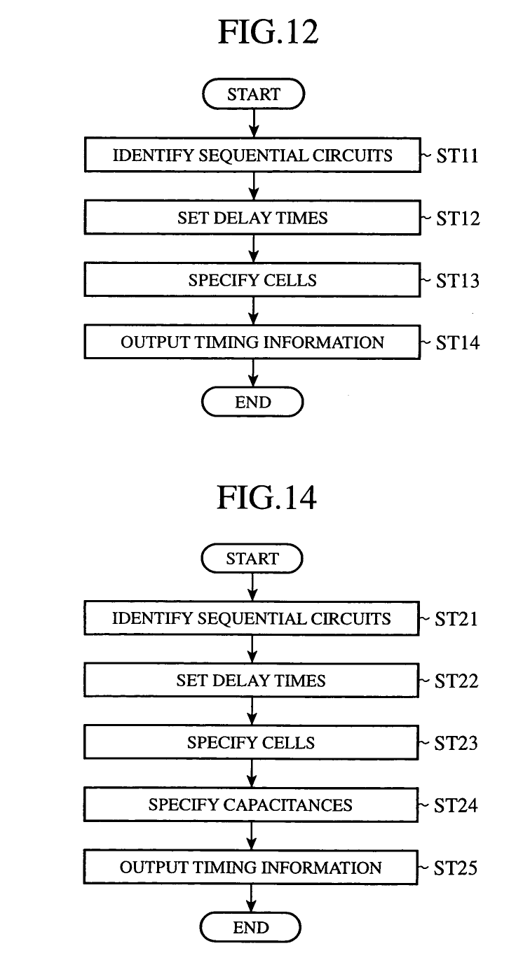

FIG. 12 is a flowchart illustrating the operation of the timing information generating apparatus shown in FIG. 11.

First, the input/output information identifying unit 2 receives the logical connection information 5. Then, it compares the logical connection information 5 with the library 7 to identify the intra-block input stage sequential circuits contributing to the information exchange with the extra-block input stage sequential circuits, and the intra-block output stage sequential circuits contributing to the information exchange with the extra-block output stage sequential circuits at step ST11.

Subsequently, the delay time calculating unit 3 receives the timing constraint information 6 and specified result output from the input/output information identifying unit 2. Then, the delay time calculating unit 3 sets the delay times from the input pins to the intra-block input stage sequential circuits and the delay times from the intra-block output stage sequential circuits to the output pins in accordance with the timing constraint information 6 at step ST12.

Subsequently, the driving cell specifying unit 12 receives the logical connection information 5. Then, it identifies the output pins of the functional block whose design has not yet been completed from the logical connection information 5, and specifies an appropriate cell registered in the library 7 as the cells for driving the output pins at step ST13.

More specifically, in the present embodiment, the driving cell specifying unit 12 identifies the output pins of the functional block whose design has not yet been completed from the logical connection information 5, and specifies the same cell registered in the library 7 uniformly for all the output pins as the cells for driving the output pins.

For example, when the functional block whose design has not yet been completed is represented as shown in FIG. 3, the pins 102 and 112 are identified as the output pins. Then, the driving cell specifying unit 12 assigns a typical cell or frequently used cell registered in the library 7 to the combinational circuit in the combinational circuit section 106 for driving the first output pin 102, and to the combinational circuit in the combinational circuit section 116 for driving the second output pin 112.

Subsequently, the timing information output unit 13 receives the set result output from the delay time calculating unit 3 and the specified result output from the driving cell specifying unit 12. Then, the timing information output unit 13 outputs the timing information 14 including the delay times from the input pins to the intra-block input stage sequential circuits, the delay times from the intra-block output stage sequential circuits to the output pins, and the information on the cells for driving the output pins at step ST14.

As described above, the present embodiment 7 is configured such that it sets the delay times from the input pins to the intra-block input stage sequential circuits and the delay times from the intra-block output stage sequential circuits to the output pins, and specifies the cells for driving the output pins in the functional block whose design has not yet been completed, and generates the timing information including the delay times and the information on the cells for driving the output pins. Accordingly, the present embodiment can fully conduct the timing verification of the higher-level functional blocks, even if the design of some lower-level functional blocks has not yet been completed, and hence their timing verification has not yet been performed.

Once the cells are determined for driving the output pins of the lower-level functional block whose design has not been completed, the delay times from the output pins to the sequential circuits in the higher-level functional block can be accurately calculated in the timing verification of the higher-level functional block. As a result, the delay times from the sequential circuits of the lower-level functional block to the sequential circuits of the higher-level functional block can be determined accurately.

### Embodiment 8

The present embodiment specifies the cells for driving the output pins individually for the output pins.

More specifically, in the present embodiment, the driving cell specifying unit 12 identifies the output pins of the functional block whose design has not yet been completed from the logical connection information 5, and specifies appropriate cells registered in the library 7 for the output pins individually as the cells for driving the output pins.

For example, the driving cell specifying unit 12 specifies the appropriate cells for the output pins individually in accordance with the extra-functional block load capacitance or load resistance of the output pins described in the timing constraint information 6. When the load capacitance or load resistance is large, it specifies the cells with large driving power. The cells for driving the output pins can be decided individually by a user from experience. When the user decides the cells, the driving cell specifying unit 12 specifies the cells for driving the output pins in accordance with the information the user inputs via an input means not shown.

For example, when the functional block whose design has not yet been completed is represented as shown in FIG. 3, the pins 102 and 112 are identified as the output pins. Then, the driving cell specifying unit 12 assigns the cell matching the extra-functional block load capacitance or load resistance of the first output pin 102 to the combinational circuit in the combinational circuit section 106 for driving the first output pin 102, and assigns the cell matching the extra-functional block load capacitance or load resistance of the second output pin 112 to the combinational circuit in the combinational circuit section 116 for driving the second output pin 112.

As described above, the present embodiment 8 is configured such that it sets the delay times from the input pins to the intra-block input stage sequential circuits and the delay times from the intra-block output stage sequential circuits to the output pins, and specifies the cells for driving the output pins in the functional block whose design has not yet been completed, and generates the timing information including the delay times and the information on the cells for driving the output pins. Accordingly, the present embodiment 8 can achieve the same advantage as the foregoing embodiment 7.

### Embodiment 9

The present embodiment is a combination of the embodiments 7 and 8. Specifically, as for some output pins, it specifies the cell for driving them uniformly for all of them as in the embodiment 7, and as for other output pins, it specifies the cells for driving them individually as in the embodiment 8.

The present embodiment 9 offers the same advantage as the embodiment 7.

### Embodiment 10

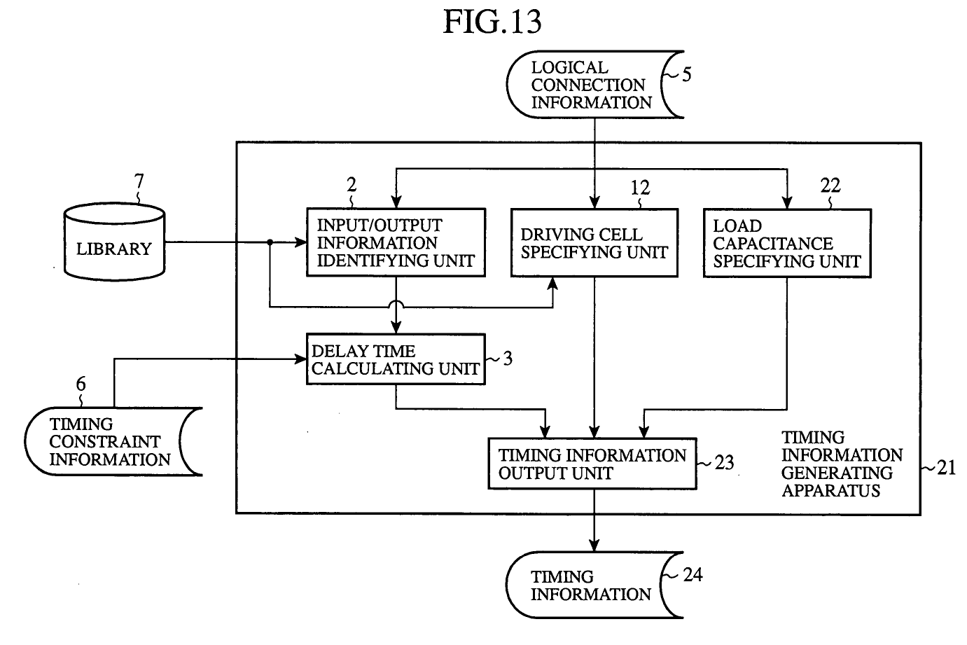

FIG. 13 is a block diagram showing a configuration of an embodiment 10 of the timing information generating apparatus in accordance with the present invention.

The timing information generating apparatus 21 comprises the input/output information identifying unit 2, the delay time calculating unit 3, the driving cell specifying unit 12, a load capacitance specifying unit 22, and a timing information output unit 23.

The input/output information identifying unit 2 and delay time calculating unit 3 have the same configuration and operation as their counterparts of the embodiment 1.

The driving cell specifying unit 12 has the same configuration and operation as its counterpart of the embodiment 7.

The load capacitance specifying unit 22 identifies the input pins and output pins of the functional block whose design has not yet been completed from the logical connection information 5, and specifies an appropriate capacitance as intra-functional block load capacitances of the input pins and output pins.

More specifically, in the present embodiment, the load capacitance specifying unit 22 identifies input pins and output pins of the functional block whose design has not yet been completed from the logical connection information 5, and specifies the same capacitance uniformly for all the input pins and output pins as the intra-functional block load capacitances of the input pins and output pins.

For example, the load capacitance specifying unit 22 specifies the same capacitance for all the input pins and output pins in accordance with: (1) the number of typical cells connected to a single net branch; (2) the average input pin capacitance of a single cell; (3) the average wiring capacitance of a single net branch; and (4) the capacitance fulfilling a timing margin. When they are large, the load capacitance specifying unit 22 specifies a large capacitance. A user can decide the intra-functional block load capacitances of the input pins and output pins uniformly from experience. When the user decides it, the load capacitance specifying unit 22 specifies the intra-functional block load capacitances of the input pins and output pins in accordance with the information the user input from the input means not shown.

The timing information output unit 23 outputs the timing information 24 including the delay times from the input pins to the intra-block input stage sequential circuits, the delay times from the intra-block output stage sequential circuits to the output pins, the information on the cells for driving the output pins, and the information on the load capacitances of the input pins and output pins.

Next, the operation of the present embodiment 10 will be described.

FIG. 14 is a flowchart illustrating the operation of the timing information generating apparatus as shown in FIG. 13.

First, the input/output information identifying unit 2 receives the logical connection information 5. Then, it compares the logical connection information 5 with the library 7 to identify the intra-block input stage sequential circuits contributing to the information exchange with the extra-block input stage sequential circuits, and the intra-block output stage sequential circuits contributing to the information exchange with the extra-block output stage sequential circuits at step ST21.

Subsequently, the delay time calculating unit 3 receives the timing constraint information 6 and specified result output from the input/output information identifying unit 2. Then, the delay time calculating unit 3 sets the delay times from the input pins to the intra-block input stage sequential circuits and the delay times from the intra-block output stage sequential circuits to the output pins in accordance with the timing constraint information 6 at step ST22.

Subsequently, the driving cell specifying unit 12 receives the logical connection information 5. Then, it identifies the output pins of the functional block whose design has not yet been completed from the logical connection information 5, and specifies an appropriate cell registered in the library 7 as the cells for driving the output pins at step ST23.

Subsequently, the load capacitance specifying unit 22 receives the logical connection information 5. Then, it identifies the input pins and output pins of the functional block whose design has not yet been completed from the logical connection information 5, and specifies the appropriate capacitance as the intra-functional block load capacitances of the input pins and output pins at step ST24.

More specifically, in the present embodiment, the load capacitance specifying unit 22 identifies the input pins and output pins of the functional block whose design has not yet been completed, and specifies the same capacitance uniformly for all the input pins and output pins as the intra-functional block load capacitances of the input pins and output pins.

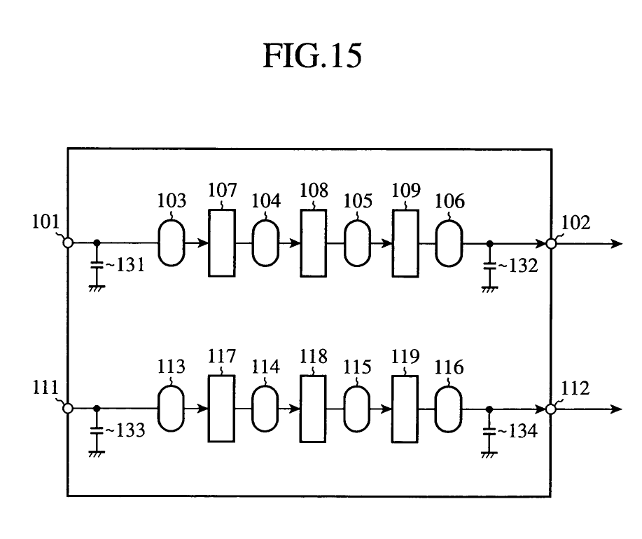

FIG. 15 is a schematic diagram used for explaining the operation of the load capacitance specifying unit of the timing information generating apparatus.

For example, assume that the functional block whose design has not yet been completed is represented as shown in FIG. 3. In this case, the pins 101 and 111 are identified as the input pins, and the pins 102 and 112 are identified as the output pins. In addition, as shown in FIG. 15, capacitances determined in accordance with the number of typical cells connected to each net branch are provided as intra-functional block load capacitances 131-134 of the first and second input pins 101 and 111 and the first and second output pins 102 and 112.

Subsequently, the timing information output unit 23 receives the set result output from the delay time calculating unit 3, the specified result output from the driving cell specifying unit 12, and the specified result output from the load capacitance specifying unit 22. Then, the timing information output unit 13 outputs the timing information 14 including the delay times from the input pins to the intra-block input stage sequential circuits, the delay times from the intra-block output stage sequential circuits to the output pins, the information on the cells for driving the output pins, and the information on the load capacitances of the input pins and output pins at step ST26.

As described above, the present embodiment 10 is configured such that it sets the delay times from the input pins to the intra-block input stage sequential circuits and the delay times from the intra-block output stage sequential circuits to the output pins, specifies the cells for driving the output pins and the intra-functional block load capacitances of the input pins and output pins in the functional block whose design has not yet been completed, and generates the timing information including the delay times, the information on the cells for driving the output pins and the information on the load capacitances of the input pins and output pins. Accordingly, the present embodiment can fully conduct the timing verification of the higher-level functional blocks, even if the design of some lower-level functional blocks has not yet been completed, and hence their timing verification has not yet been performed.

Once the intra-functional block load capacitances of the input pins of the lower-level functional block whose design has not been completed, the delay times from the sequential circuits of the higher-level functional block to the input pins can be accurately calculated in the timing verification of the higher-level functional block. As a result, the delay times from the sequential circuits of the higher-level functional block to the sequential circuits of the lower-level functional block can be determined accurately. In addition, once the cells for driving the output pins of the lower-level functional block whose design has not been completed, and the intra-functional block load capacitances of the output pins have been determined, the delay times from the output pins to the sequential circuits of the higher-level functional block can be accurately calculated in the timing verification of the higher-level functional block. As a result, the delay times from the sequential circuits of the lower-level functional block to the sequential circuits of the higher-level functional block can be determined accurately.

### Embodiment 11

The present embodiment specifies the load capacitances individually for the input pins.

More specifically, in the present embodiment, the load capacitance specifying unit 22 identifies the input pins and output pins of the functional block whose design has not yet been completed from the logical connection information 5, and specifies the appropriate capacitances for the individual input pins as the intra-functional block load capacitances of the input pins.

For example, the load capacitance specifying unit 22 specifies the capacitances for the input pins individually in accordance with the driving power of the cells for driving the input pins described in the timing constraint information 6. When the driving power of the cell is large, it specifies a large capacitance. A user can decide the intra-functional block load capacitances of the input pins individually from experience. When the user makes a decision, the load capacitance specifying unit 22 specifies the intra-functional block load capacitances of the input pins in accordance with the information the user inputs via an input means not shown.

For example, assume that the functional block whose design has not yet been completed is represented as shown in FIG. 3. In this case, the pins 101 and 111 are identified as the input pins, and the pins 102 and 112 are identified as the output pins. In addition, as shown in FIG. 15, a capacitance determined in accordance with the driving power of the cell for driving the first input pin 101 is assigned to the intra-functional block load capacitance 131 of the first input pin 101, and a capacitance determined in accordance with the driving power of the cell for driving the second input pin 111 is assigned to the intra-functional block load capacitance 133 of the second input pin 111.

The same capacitance is specified uniformly for all the output pins as the intra-functional block load capacitances of the output pins as in the foregoing embodiment 10.

As described above, the present embodiment 11 is configured such that it sets the delay times from the input pins to the intra-block input stage sequential circuits and the delay times from the intra-block output stage sequential circuits to the output pins, specifies the cells for driving the output pins, and the intra-functional block load capacitances of the input pins and output pins in the functional block whose design has not yet been completed, and generates the timing information including the delay times, the information on the cells for driving the output pins and the information on the load capacitances of the input pins and output pins. Accordingly, the present embodiment can offer the same advantage of the foregoing embodiment 10.

### Embodiment 12

The present embodiment specifies the load capacitances individually for the output pins.

More specifically, in the present embodiment, the load capacitance specifying unit 22 identifies the input pins and output pins of the functional block whose design has not yet been completed from the logical connection information 5, and specifies the appropriate capacitances for the individual output pins as the intra-functional block load capacitances of the output pins.

For example, the load capacitance specifying unit 22 specifies the capacitances for the output pins individually in accordance with the driving power of the cells for driving the output pins, which is expected from the extra-functional block load capacitances and load resistances of the output pins described in the timing constraint information 6. When the expected driving power of the cell is large, it specifies a large capacitance. A user can decide the intra-functional block load capacitances of the output pins individually from experience. When the user makes a decision, the load capacitance specifying unit 22 specifies the intra-functional block load capacitances of the output pins in accordance with the information the user inputs via an input means not shown.

For example, assume that the functional block whose design has not yet been completed is represented as shown in FIG. 3. In this case, the pins 101 and 111 are identified as the input pins, and the pins 102 and 112 are identified as the output pins. In addition, as shown in FIG. 15, a capacitance determined in accordance with the expected driving power of the cell for driving the first output pin 102 is assigned to the intra-functional block load capacitance 132 of the first input pin 101, and a capacitance determined in accordance with the expected driving power of the cell for driving the second output pin 112 is assigned to the intra-functional block load capacitance 134 of the second output pin 112.

The same capacitance is specified uniformly for all the input pins as the intra-functional block load capacitances of the input pins as in the foregoing embodiment 10.

As described above, the present embodiment 12 is configured such that it sets the delay times from the input pins to the intra-block input stage sequential circuits and the delay times from the intra-block output stage sequential circuits to the output pins, specifies the cells for driving the output pins, and the intra-functional block load capacitances of the input pins and output pins in the functional block whose design has not yet been completed, and generates the timing information including the delay times, the information on the cells for driving the output pins and the information on the load capacitances of the input pins and output pins. Accordingly, the present embodiment can offer the same advantage of the foregoing embodiment 10.

### Embodiment 13

The present embodiment is a combination of the embodiments 10-12. Specifically, as for some input pins and output pins, it specifies the same load capacitance uniformly for all the input pins and output pins as in the foregoing embodiment 10. As for still other input pins, it specifies the load capacitances individually for the input pins as in the foregoing embodiment 11, and as for other output pins, it specifies the load capacitances individually for the output pins as in the foregoing embodiment 12.

The present embodiment 8 offers the same advantage as the embodiment 10.

Although the foregoing embodiments 1-6 are described by way of example using the clock signals with the same period, this is not essential. For example, utilizing the clock signals with different periods also enables the calculation of the delay times from the input pins to the intra-block input stage sequential circuits and the delay times from the intra-block output stage sequential circuits to the output pins.

In addition, although the foregoing embodiments 7-9 are described by way of example using the combinational circuits as the cells for driving the output pins, this is not essential. For example, when the cells for driving the output pins consists of a sequential circuit, they are specified in the same manner.

The foregoing embodiments of the timing information generating apparatus are used for conducting the timing verification of a logic design, floor planning, or layout design.

What is claimed is:

1. A timing information generating apparatus for generating timing information on a functional block, said timing information generating apparatus comprising:
an input/output information identifying unit for identifying intra-block input stage sequential circuits and intra-block output stage sequential circuits by comparing logical connection information with a library in which cells used for designing the functional block are registered, said intra-block input stage sequential circuits being placed in the functional block and contributing to information exchange with extra-block input stage sequential circuits outside said functional block through input pins, said intra-block output stage sequential circuits being placed in the functional block and contributing to information exchange with extra-block output stage sequential circuits outside said functional block through output pins, and the logical connection information describing connection relationships between circuit components constituting the functional block, between the circuit components and the input pins and between the circuit components and the output pins;
a delay time calculating unit for calculating first delay times from the input pins to the intra-block input stage sequential circuits in accordance with timing constraint information describing timing constraint on said functional block, and second delay times from said intra-block output stage sequential circuits to said output pins; and
a timing information output unit for outputting timing information including the first delay times and the second delay times.

2. The timing information generating apparatus according to claim 1, wherein said delay time calculating unit sets the first delay times and the second delay times such that all the input pins and output pins satisfy conditions described in the timing constraint information.

3. The timing information generating apparatus according to claim 1, wherein said delay time calculating unit sets the first delay times and the second delay times such that the input pins and output pins satisfy conditions described in the timing constraint information with leaving a same spare time uniformly for all the input pins and output pins.

4. The timing information generating apparatus according to claim 1, wherein said delay time calculating unit sets the first delay times and the second delay times such that the input pins and output pins satisfy conditions described in the timing constraint information with leaving different spare times for the individual input pins and output pins.

5. The timing information generating apparatus according to claim 1, wherein said delay time calculating unit sets the first delay times and the second delay times such that the input pins and output pins dissatisfy conditions described in the timing constraint information with leaving a same shortage of time uniformly for all the input pins and output pins.

6. The timing information generating apparatus according to claim 1, wherein said delay time calculating unit sets the first delay times and the second delay times such that the input pins and output pins dissatisfy conditions described in the timing constraint information with leaving different shortages of time for the individual input pins and output pins.

7. The timing information generating apparatus according to claim 1, further comprising a driving cell specifying unit for specifying at least one appropriate cell registered in said library as the cells for driving the output pins.

8. The timing information generating apparatus according to claim 7, wherein said driving cell specifying unit specifies a same cell for all the output pins uniformly as the cells for driving the output pins.

9. The timing information generating apparatus according to claim 7, wherein said driving cell specifying unit specifies appropriate cells for the individual output pins as the cells for driving the output pins.

10. The timing information generating apparatus according to claim 7, further comprising a load capacitance specifying unit for specifying at least one appropriate capacitance as intra-functional block load capacitances of the input pins and output pins.

11. The timing information generating apparatus according to claim 10, where in said load capacitance specifying unit specifies a same capacitance uniformly for all the input pins and output pins as the intra-functional block load capacitances of the input pins and output pins.

12. The timing information generating apparatus according to claim 10, wherein said load capacitance specifying unit specifies appropriate capacitances for the individual input pins as the intra-functional block load capacitances of the input pins.

13. The timing information generating apparatus according to claim 10, wherein said load capacitance specifying unit specifies appropriate capacitances for the individual output pins as the intra-functional block load capacitances of the output pins.

14. A timing information generating apparatus for generating timing information on a functional block, said timing information generating apparatus comprising:
an input/output information identifying unit for identifying an intra-block input stage sequential circuit and an intra-block output stage sequential circuit by comparing logical connection information with a library in which cells used for designing the functional block are registered, said intra-block input stage sequential circuit being placed in the functional block and contributing to information exchange with an extra-block input stage sequential circuit outside said functional block through an input pin, said intra-block output stage sequential circuit being placed in the functional block and contributing to information exchange with an extra-block output stage sequential circuit outside said functional block through an output pin, and the logical connection information describing connection relationships between circuit components constituting the functional block, between the circuit components and the input pin and between the circuit components and the output pin;
a delay time calculating unit for calculating a first delay time from the input pin to the intra-block input stage sequential circuit in accordance with timing constraint information describing timing constraint on said functional block, and a second delay time from said intra-block output stage sequential circuit to said output pin; and
a timing information output unit for outputting timing information including the first delay time and the second delay time.
